(19) United States
(12) Patent Application Publication
(10) Pub. No.: US 2020/0044467 A1
(43) Pub. Date: Feb. 6, 2020

(54) APPARATUS FOR AND METHODS OF FAST BATTERY CHARGING

(71) Applicant: FreeWire Technologies, Inc., San Leandro, CA (US)

(72) Inventors: Arcady SOSINOV, San Francisco, CA (US); Richard STEELE, San Leandro, CA (US)

(21) Appl. No.: 16/481,468

(22) PCT Filed: Jan. 29, 2018
(86) PCT No.: PCT/US18/15763

§ 371 Date: Jul. 29, 2019

Related U.S. Application Data
(60) Provisional application No. 62/451,655, filed on Jan. 27, 2017.

(51) Int. Cl. H02J 7/00; H02J 7/34; H01M 10/44

(52) U.S. Cl. CPC H02J 7/0045; H02J 7/0054; H02J 7/0073; H01M 10/44; H02J 7/0004; H02J 7/345

(57) ABSTRACT

One aspect of the present invention pertains to a method of charging electric storage devices such as batteries. Another aspect of the present invention pertains to a system for charging electric storage devices such as batteries.

### CROSS-REFERENCE TO RELATED APPLICATIONS

The present application claims benefit of U.S. Provisional Patent application Ser. No. 62/451,655, entitled “APPARATUS FOR AND METHODS OF FAST BATTERY CHARGING,” to Arcady SOSINOV and Richard STEELE, filed Jan. 27, 2017. The present application is related to: U.S. Provisional Patent application Ser. No. 61/977,493, entitled “SYSTEMS, APPARATUS, METHODS OF BATTERY CHARGING USING A MOBILE CHARGER,” to Arcady SOSINOV, Sanat KAMAL BAHL, Love KOTHARI, and Sameer MEHDIRATTA, filed Apr. 9, 2014 and U.S. Nonprovisional Patent Application Ser. No. 14/681,415, entitled “SYSTEMS, APPARATUS, AND METHODS OF CHARGING ELECTRIC VEHICLES” to Arcady SOSINOV, Sanat KAMAL BAHL, Love KOTHARI, and Sameer MEHDIRATTA, filed Apr. 8, 2015; the content of all these applications is incorporated herein in its entirety by this reference for all purposes.

### BACKGROUND

The use of electric vehicles for applications such as transportation is expected to grow. A variety of options and technologies exist that may solve one or more expected challenges that may result from the desire to use electric vehicles. The present inventors have developed one or more solutions that may address one or more problems related to providing electric power such as for charging batteries such as for electric vehicles.

### SUMMARY

One aspect of the present invention pertains to an apparatus for charging electric storage devices such as batteries for electric vehicles. Another aspect of the present invention pertains to a system for charging electric storage devices such as batteries for electric vehicles. Another aspect of the present invention pertains to a method of charging electric energy storage devices such as batteries for electric vehicles.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a diagram of a process flow according to one or more embodiments of the present invention.

FIG. 2 is a diagram of a system according to one or more embodiments of the present invention.

FIG. 3 is a diagram of a system according to one or more embodiments of the present invention.

FIG. 4 is a diagram of a system according to one or more embodiments of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding embodiments of the present invention.

### DESCRIPTION

In the following description of the figures, identical reference numerals have been used when designating substantially identical elements or processes that are common to the figures.

Unless otherwise defined, all technical and scientific terms used herein have the same meaning as commonly understood by one of ordinary skill in the art to which this invention belongs. In case of conflict with publications, patent applications, patents, and other references mentioned incorporated herein by reference, the present specification, including definitions, will control.

Various embodiments the present invention may include any of the described features, alone or in combination. Other features and/or benefits of this disclosure will be apparent from the following description.

For the following defined terms, these definitions shall be applied, unless a different definition is given in the claims or elsewhere in this specification.

“Autonomous” is defined herein as meaning capable of operating without direct real-time control by a person(s) or operating without direct real-time control by a person(s).

“Drive battery” is defined herein as meaning a battery that provides power for propelling an electric vehicle.

“Complete depletion” is defined herein as meaning reducing the stored power of a battery to the lowest level recommended by its manufacturer.

“Electric vehicle” (EV) is defined herein as meaning a vehicle for which at least some of the energy for moving the vehicle is derived from an onboard stored electric power supply such as a battery and/or a capacitor. Examples of electric vehicles include, but are not limited to, a battery electric vehicle, a capacitor electric vehicle, a hybrid electric vehicle, and a plug-in hybrid electric vehicle.

“Mobile” is defined herein as meaning capable of moving and/or being moved as in being portable and is not fixed to one position or place, but optionally may be attached by way of a releasable connection to an electric power line, a fuel line, an information transfer line, or combinations thereof.

“Motorized” is defined herein as meaning capable of self-propulsion such as having a motor, an engine, or other drive mechanism to accomplish locomotion.

“Remote control” is defined herein as meaning operating or being controlled from a distance.

“Wired” is defined herein as meaning having a solid physical connection for conveying information, data, signals, and/or energy.

All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

As will be understood by a person skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as an “apparatus”, a “circuit,” a “module” or a “system.” Furthermore, aspects of the present invention may take the form of a computer program product embodied in one or more non-transitory computer readable medium(s) having computer readable program code embodied, e.g., stored, thereon.

Any combination of one or more non-transitory computer readable mediums may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java(TM), Smalltalk, C++ or the like and conventional procedural programming languages, such as the “C” programming language, such as .net framework and Microsoft Corporation programming languages and databases, such as HTML5, Android Mobile applications and Apple Corporation iOS mobile applications, or similar programming languages. The program code may execute entirely on a local computer, partly on the local computer, as a stand-alone software package, partly on the local computer and partly on a remote computer, or entirely on the remote computer or server. In the latter scenario, the remote computer may be connected to the local computer through any type of network, including a local area network (LAN) or a wide area network (WAN), or the connection may be made to an external computer (for example, through the Internet using an Internet Service Provider). The program code may reside on remote servers and software networks such as for cloud computing such as, but not limited to, Amazon Web Services, Google cloud etc. Mobile applications of the program code may also be available for download from services such as Apple App store and Google play.

Aspects of the present invention are described below with reference to flowchart illustrations and/or block diagrams of methods, processes, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions which execute via the processor of the computer, other programmable data processing apparatus, or other devices enable implementation of the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following description is primarily directed towards charging electric vehicles, particularly electric automobiles. It is to be understood that one or more embodiments of the present invention apply to other electric vehicles such as, but not limited to, electric trucks, electric vans, electric buses, electric bikes, and electric motorcycles.

The following documents are incorporated herein in their entirety by this reference for all purposes: European Patent Application 2402205A1, U.S. Patent Application 2012/0005031, U.S. Patent Application 2018/0015834 A1, U.S. Patent Application 2015/0183329 A1, U.S. Pat. No. 8,169,186, and U.S. Pat. No. 8,473,131.

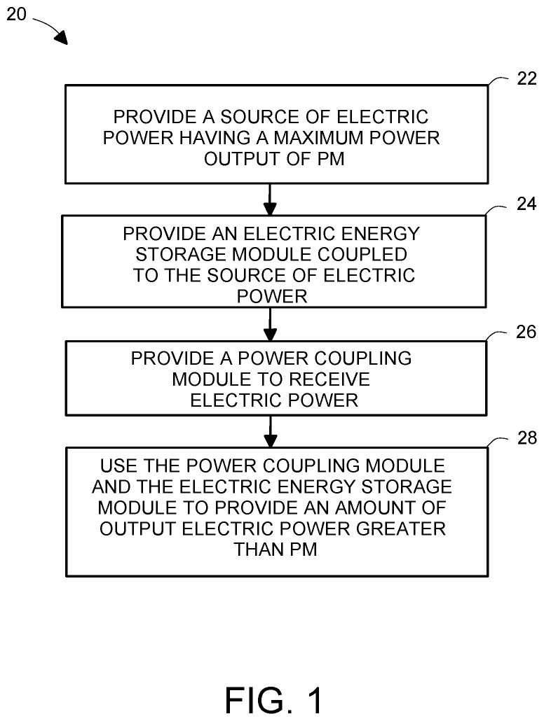

Reference is now made to FIG. 1 where there is shown a process flow 20 according to one or more embodiments of the present invention for providing electric power to a load such as to a battery such as to a battery for an electric vehicle. The process flow 20 includes process 22, process 24, process 26, and process 28.

Process 22 involves providing a source of electric power having a maximum power output of P_{M} which is a numerical value having units of power. Process 22 may include providing sources of electric power such as, but not limited to, a standard electrical outlet such as for standard household or building electric power, standard power sources for Level II electric vehicle charging, a Level II electric vehicle charging station or connection, a power source such as the invention disclosed in commonly owned U.S. patent application Ser. No. 14/681415 (now U.S. Pat. No. 9,592,742), other source of electric power. Optionally, the source of electric power may be provided by way of a connector such as, but not limited to, a SAE Surface Vehicle Recommended Practice J1772, SAE Electric Vehicle Conductive Charge Coupler.

Process 24 involves providing an electric energy storage module coupled to the source of electric power to receive electric power at an amount up to P_{M} to store electric energy or to store other forms of energy which can be converted back into electric energy. Process 24 may include providing an energy storage module such as, but not limited to energy storage modules that use batteries, capacitors, and/or other types of energy storage devices that receive electricity directly or indirectly such as fuel cells, and other less conventional types of energy storage devices.

According to one or more embodiments of the present invention, the electric energy storage module may include a hydrogen fuel cell and a hydrogen storage module. The electric power input to the electric energy storage module can be used to electrolyze water to produce hydrogen. Optionally, the fuel cell may be run in reverse to perform electrolysis of water or a separate electrolyzer unit may be included with the electric energy storage module. The hydrogen generated from the electric power received at an amount up to P_{M} can be stored in the hydrogen storage module. Hydrogen can be drawn from the hydrogen storage module and used by the fuel cell to provide an output of electric power high enough to accomplish fast charging electric vehicles.

Process 26 involves providing a power coupling module connected with the electric energy storage module to receive electric power. Process 26 may include providing a power coupling module that includes connectors and related components such as, but not limited to those used for fast charging connectors for electric vehicles such as for the CHAdeMo standard, such as for the SAE Combo standard, such as for the GBT standard, such as for Tesla Motors Incorporated charging connector technology along with any other circuitry, circuit elements, and components to allow connecting and charging an electric vehicle and/or for providing electric power to other types of loads. According to one or more embodiments of the present invention, the power coupling module includes a DC to DC converter to accomplish increasing the voltage of energy received from the energy storage module to voltages high enough for high-speed electric vehicle charging.

Process 28 involves using the power coupling module and the electric energy storage module to provide an amount of output electric power to the load greater than P_{M}. Process 28 may be repeated to charge different loads or to recharge the same load. According to one embodiment of the present invention process flow 20 may be repeated to charge electric vehicle batteries.

According to one or more embodiments of the present invention process 28 is performed as a batch processes in which the output power is applied to sequentially processed loads such as sequentially presented batteries such as for electric vehicles. In other words, according to one or more embodiments of the present invention process 28 can be performed to charge an electric vehicle followed by charging another electric vehicle. Optionally, the charging of electric vehicle or application of electric power to the load may be performed to a desired level or for a desired amount such as to the point of substantially fully charging the electric vehicle or partially charging the electric vehicle.

According to one or more embodiments of the present invention, process 28 performed as batch processing and having sufficiently long time delay between two or more batches to prevent complete depletion of the electric energy storage module. According to one embodiment, the delays are long enough to allow recharging of the electric energy storage module sufficiently for continued batch operation.

According to one or more embodiments of the present invention, process flow 20 is performed for a load that includes an electric vehicle battery. Also the maximum input power P_{M} is the available power from a standard household or building power outlet. There can be wide variations in the available voltages and currents for standard household or building power outlets. Typical voltages may range from less than 90 volts AC to over 265 volts AC. At present, even the higher amounts of power available at household and building standard outlets are too low to meet the requirements for some of the desired high charging rates. In other words, the maximum available power at standard household and building electrical sources are typically too low for high rate electric vehicle charging.

Process flow 20, according to one or more embodiments of the present invention, overcome one or more limitations in achieving high output powers for applying electric power to loads such as electric vehicle batteries. Using limited available maximum power sources such as those available for standard household and buildings electricity requirements, embodiments of the present invention according to process flow 20 can provide amounts of output electric power to the load greater than 30 kW. According to another embodiment of the present invention process flow 20 can provide amounts of output electric power to the load greater than 40 kW. According to another embodiment the present invention, process flow 20 can provide amounts of output electric power to the load greater than 50 kW. According to another embodiment the present invention, process flow 20 can provide amounts of output electric power to the load greater than 50 kW. According to one or more embodiments of the present invention, process flow 20 can provide amounts of output electric power to the load from 20 kW to 350 kW and all values, ranges, and subranges subsumed therein.

For one or more embodiments of the present invention, process flow 20 provides the electric energy storage module coupled to the source of electric power by way of a releasable connection so as to allow easy and/or fast connection and disconnection between the energy storage module and the source of electric power. For one or more other embodiments of the present invention, process flow 20 provides the electric energy storage module coupled to the source of electric power by way of a non-releasable connection or substantially permanent connection between the energy storage module and the source of electric power.

According to one or more embodiments of the present invention, process flow 20 includes having the energy storage module and the power coupling module configured so that they are portable, mobile, self driven, self driven with remote control, and/or self driven with self direction. Examples of configurations for one or more embodiments of the present invention include mounting or connecting the energy storage module and/or the power coupling module to a support such as, but not limited to a frame, platform, housing, wheeled cart, motorized cart, or other type of substantially rigid support to facilitate carrying, carting, and/or pulling.

One or more embodiments of the present invention include a method of providing electric power to a load. The method includes a process flow of providing electric power up to a maximum of P_{M} from a source of electric power to an electric energy storage module while using energy from the electric energy storage module to provide electric power greater than P_{M} to a load.

One or more embodiments of the present invention include a method of providing electric power to charge an electric vehicle battery. The method comprises providing electric power up to a maximum of P_{M} from a source of electric power to an electric energy storage module while using energy from the electric energy storage module to provide electric power greater than P_{M} to the electric vehicle battery.

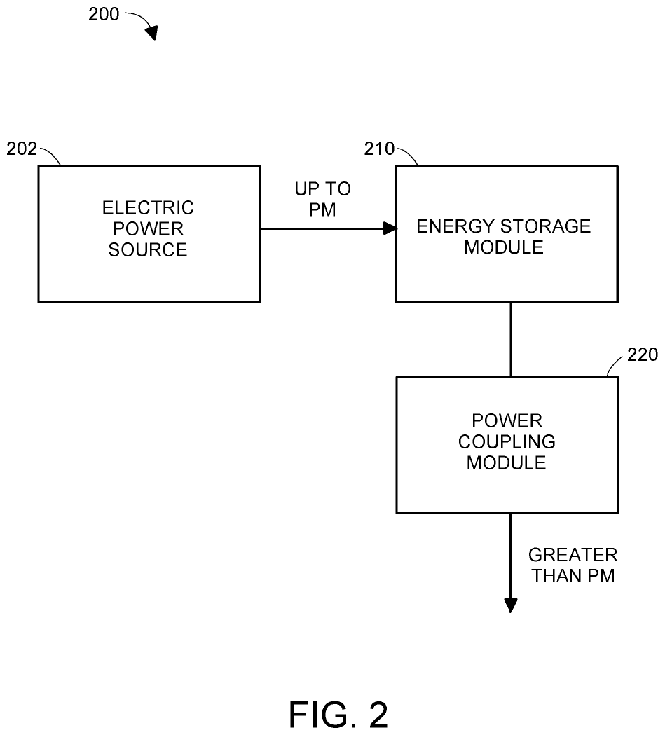

Reference is now made to FIG. 2 where there is shown a diagram, according to one embodiment of the present invention, of a system 200 for charging electric vehicles, system 200 comprises a source of electric power 202 having a maximum power output of P_{M} where P_{M} is a numerical value having units of power. System 200 also includes an electric energy storage module 210 coupled to the source of electric power to receive electric power at an amount up to P_{M} to store electric energy. System 200 also includes a power coupling module 220 connected with electric energy storage module 210 to receive electric power and to provide an amount of output electric power greater than P_{M} to accomplish charging the electric vehicles.

According to one or more embodiments of the present invention, system 200 uses an electric power source 202 such as electric power available at standard household and building electrical outlets and system 200 provides an output power from 20 kW to 350 kW and all values, ranges, and subranges subsumed therein.

According to one or more embodiments of the present invention, system 200 uses an electric power source 202 such as electric power available at standard household and building electrical outlets and system 200 provides an output power greater than 20 kW. According to one or more embodiments of the present invention, system 200 uses an electric power source 202 such as electric power available at standard household and building electrical outlets and provides an output power greater than 30 kW. According to one or more embodiments of the present invention, system 200 uses an electric power source 202 such as electric power available at standard household and building electrical outlets and provides an output power greater than 40 kW. According to one or more embodiments of the present invention, system 200 uses an electric power source 202 such as electric power available at standard household and building electrical outlets and provides an output power greater than 50 kW.

According to one or more embodiments of the present invention, energy storage module 210 comprises one or more batteries and/or one or more capacitors as part of the energy storage system. In other words, energy storage module 210 may comprise batteries such as, but not limited to, lithium batteries which may be new batteries or second life batteries. Optionally combinations of batteries and capacitors may be included in energy storage module 210.

As an alternative for one or more embodiments of the present invention, energy storage module 210 may be configured to store other forms of energy which can be converted back into electric energy. More specifically, electric energy received by the energy storage module may be converted into another form of energy which is stored by energy storage module 210. As needed, the stored energy can be converted back into electrical energy and used to accomplish high rate electric vehicle charging.

According to one or more embodiments of the present invention, electric energy storage module 210 may include a hydrogen fuel cell and a hydrogen storage module. The electric power input to the electric energy storage module can be used to electrolyze water to produce hydrogen. Optionally, the fuel cell may be run in reverse to perform electrolysis of water or a separate electrolyzer unit may be included with electric energy storage module 210. The hydrogen generated from the electric power received at an amount up to P_{M} can be stored in the hydrogen storage module. Hydrogen can be drawn from the hydrogen storage module and used by the fuel cell to provide an output of electric power high enough to accomplish fast charging electric vehicles.

According to one or more embodiments of the present invention, electric energy storage module 210 further comprises one or more circuits, electrical elements, and/or electrical components such as, but not limited to AC to DC converters, DC to DC converters, switches, transistors, transformers, and/or rectifiers to receive electric power for charging while providing electric power to the power coupling module.

Power coupling module 220 may include substantially any type of conductive connector that the electric vehicle is configured to receive. Conductive connectors, suitable for electric vehicle charging, are commercially available and new types of conductive connectors are being developed. Examples of some types of currently available conductive connectors designed for charging electric vehicles include but are not limited to, CHAdeMO connector, GBT connector, and SAE Combo connector.

According to one or more embodiments of the present invention, power coupling module 210 may include a DC to DC converter to accomplish increasing the voltage of energy received from energy storage module 210 to voltages high enough for high-speed electric vehicle charging.

One or more embodiments of the present invention include a system. The system comprises an electric energy storage module substantially the same as electric energy storage module 210 as described supra and a power coupling module substantially the same as power coupling module 220 as described supra. The system further includes one or more circuits (not shown in figures) to receive electric power from a source of electric power having a maximum capacity power capacity P_{M} to charge the electric energy storage module while the electric energy storage module provides energy for the power coupling module to output power greater than P_{M} for charging a battery or for providing electric power to other types of loads. As an option for one or more embodiments of the present invention, the output electric power greater is from 20 kW to 350 kW and all values, ranges, and subranges subsumed therein.

According to one or more embodiments of the present invention, the system can use an electric power source such as electric power available at standard household and building electrical outlets and provides an output power greater than 20 kW. According to one or more embodiments of the present invention, the system can use an electric power source such as electric power available at standard household and building electrical outlets and provides an output power greater than 30 kW. According to one or more embodiments of the present invention, the system uses an electric power source such as electric power available at standard household and building electrical outlets and provides an output power greater than 40 kW. According to one or more embodiments of the present invention, the system uses an electric power source such as electric power available at standard household and building electrical outlets and provides an output power greater than 50 kW. According to one or more embodiments of the present invention, the system uses an electric power source less than 20 kW. According to one or more embodiments of the present invention, the system uses an electric power source less than 20 kW and the output electric power greater than is from 20 kW to 120 kW and all values, ranges, and subranges subsumed therein.

System 200 may also include a control and communication system (not shown in FIG. 2) connected with energy storage module 210 and/or power coupling module 220 so as to execute instructions, transmit data, receive data, control operation, and/or combinations thereof. According to one or more embodiments of the present invention, the control and communication system includes components for wireless communication and/or wired communication. The control and communication system may be configured with firmware, hardware, and/or software so as to perform processes and/or execute computer code for actions such as, but not limited to, control the operation of system 200, collect data on the operation of system 200, transmit data for the operation of system 200, transmit charging status data for charging electric vehicle, transmit charging completion data to a user, transmit the availability of system 200 to charge electric vehicles, and combinations thereof.

According to one or more embodiments of the present invention, electric power source 202 for system 200 may be a power source such as a Level II electric vehicle charging station. For such embodiments, system 200 essentially converts the Level II charging station to a fast charging station by providing higher power output meeting requirements for fast electric vehicle charging. In addition, the control and communication system essentially converts Level II charging stations that may not have communication and control capabilities into a smart charging station with the capability of collecting data, sending data, sending messages, receiving messages, and combinations thereof.

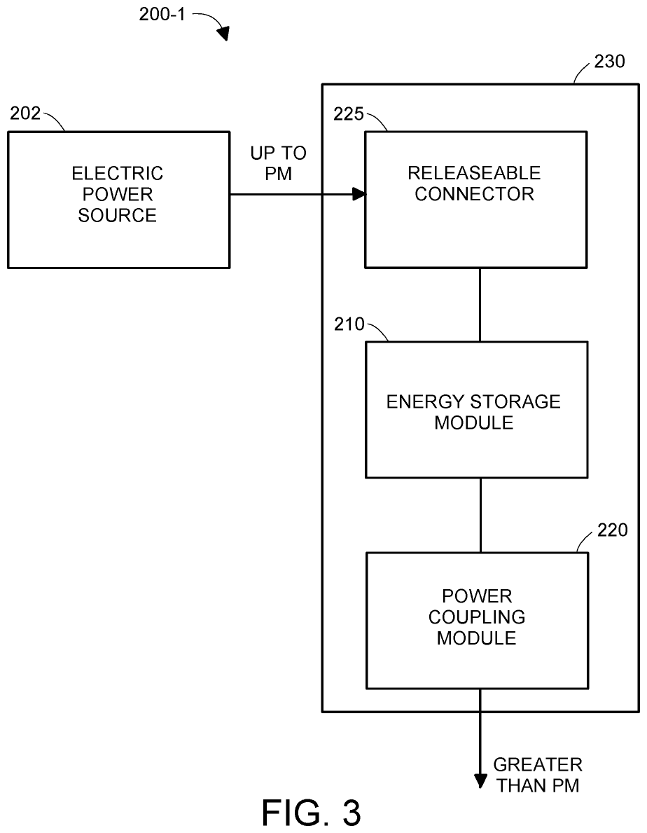

Reference is now made to FIG. 3 where there is shown a diagram, according to one embodiment of the present invention, of a system 200-1 for charging electric vehicles. System 200-1 comprises a source of electric power 202 having a maximum power output of P_{M} where P_{M} is a numerical value having units of power. System 200-1 also includes an electric energy storage module 210 coupled to the source of electric power to receive electric power at an amount up to P_{M} to store electric energy. System 200-1 also includes a releasable connector 225 to couple electrical power from the electric power source 202 to energy storage module 210. System 200-1 also includes a power coupling module 220 connected with electric energy storage module 210 to receive electric power and to provide an amount of output electric power greater than P_{M} to accomplish charging the electric vehicles. System 200-1 also includes a support 230 to provide support for mounting and/or attaching energy storage module 210 and power coupling module 220. Optionally, releasable connector 225 may be supported by support 230 either directly or indirectly.

According to one or more embodiments of the present invention system 200-1 further comprises support 230 configured as a motorized cart. Energy storage module 210, power coupling module 220, and releasable connector 225 are mounted on support 230. Having support 230 configured as a motorized cart enables locomotion of energy storage module 210 and power coupling module 220 such as for moving from a first location to a second location. Optionally, releasable connector 225 is also coupled to support 230.

System 200-1 may also include a control and communication system (not shown in FIG. 3) supported by support 230 so that locomotion of energy storage module 210 and power coupling module 220 from a first location to a second location can be accomplished by remote control and/or commands from the control and communication system. The control and communication system may also be connected with energy storage module 210, releasable connector 225, and/or power coupling module 220 so as to execute instructions, transmit data, receive data, control operation, and/or combinations thereof.

According to one or more embodiments of the present invention, the control and communication system includes components for wireless communication and/or wired communication. The control and communication system may be configured so as to perform processes and/or execute computer code for actions such as, but not limited to collect data on the operation of system 200-1, transmit data for the operation of system 200-1, transmit charging status data for charging electric vehicles, transmit charging completion data to a user, transmit the availability of system 200-1 to charge electric vehicles, and combinations thereof.

According to one or more embodiments of the present invention, electric power source 202 for system 200-1 may be a power source such as a Level II electric vehicle charging station. For such embodiments, system 200-1 essentially converts the Level II charging station to a fast charging station by providing higher power output meeting requirements for fast electric vehicle charging. In addition, the control and communication system essentially converts Level II charging stations that may not have communication and control capabilities into a smart charging station with the capability of collecting data, sending data, sending messages, receiving messages, and combinations thereof.

According to one or more embodiments of the present invention, energy storage module 210 comprises one or more batteries and/or one or more capacitors that may be used together as part of the energy storage system.

According to one or more embodiments of the present invention, electric energy storage module 210 further comprises one or more circuits, electrical elements, and/or electrical components such as, but not limited to AC to DC converters, DC to DC converters, switches, transistors, transformers, and/or rectifiers to receive electric power for charging while providing electric power to the power coupling module.

Power coupling module 220 may include substantially any type of conductive connector that the electric vehicle is configured to receive. Conductive connectors, suitable for electric vehicle charging, are commercially available and new types of conductive connectors are being developed. Examples of some types of currently available conductive connectors designed for charging electric vehicles include but are not limited to, CHAdeMO connector, GBT connector, and SAE Combo connector.

One or more embodiments of the present invention include a system. The system comprises an electric energy storage module substantially the same as electric energy storage module 210 as described supra and a power coupling module substantially the same as power coupling module 220 as described supra.

The system further includes one or more circuits (not shown in figures) to receive electric power from a source of electric power having a maximum capacity power capacity P_{M} to charge the electric energy storage module while the electric energy storage module provides energy for the power coupling module to output power greater than P_{M} for charging a battery or for providing electric power to other types of loads. As an option for one or more embodiments of the present invention, the output electric power greater is from 20 kW to 350 kW and all values, ranges, and subranges subsumed therein.

According to one or more embodiments of the present invention, the system can use an electric power source such as electric power available at standard household and building electrical outlets and provides an output power greater than 20 kW. According to one or more embodiments of the present invention, the system can use an electric power source such as electric power available at standard household and building electrical outlets and provides an output power greater than 30 kW. According to one or more embodiments of the present invention, the system uses an electric power source such as electric power available at standard household and building electrical outlets and provides an output power greater than 40 kW. According to one or more embodiments of the present invention, the system uses an electric power source such as electric power available at standard household and building electrical outlets and provides an output power greater than 50 kW. According to one or more embodiments of the present invention, the system uses an electric power source less than 20 kW.

According to one or more embodiments of the present invention, the system uses an electric power source less than 20 kW and the output electric power greater than is from 20 kW to 120 kW and all values, ranges, and subranges subsumed therein.

According to one or more embodiments of the present invention, the system includes having the energy storage module and the power coupling module configured so that they are portable, mobile, self driven, self driven with remote control, and/or self driven with self direction. Examples of configurations for one or more embodiments of the present invention include mounting or connecting the energy storage module and/or the power coupling module to a support such as, but not limited to a frame, platform, housing, wheeled cart, motorized cart, or other type of substantially rigid support to facilitate carrying, carting, driving, and/or pulling the system from one location to another location.

According to one or more embodiments of the present invention, the source of electric power may be provided by way of a connector such as, but not limited to, a SAE Surface Vehicle Recommended Practice J1772, SAE Electric Vehicle Conductive Charge Coupler to the energy storage module. For one or more embodiments of the present invention, releasable connector 225 may comprise a connector such as a J1772 connector.

Embodiments of the present invention may use a variety of types of power coupling modules. The type of power coupling element selected for an electric vehicle charger will depend on the type of coupling required to transfer power to the electric vehicle. Optionally, and electric vehicle charger according to one embodiment of the present invention may have more than one type of power coupling element so as to be able to charge more than one type of electric vehicle. According one embodiment of the present invention, the power coupling module comprises a conductive connector to conduct electric power to a drive battery of the electric vehicle.

When configured as a motorized cart, systems according to one or more embodiments of the present invention include a typical structure of a cart with the addition of a motor, an engine, or other drive system. More specifically, the motorized cart may include a housing, a frame, a base, and/or a platform having one or more wheels or treads rotatably coupled thereto. The motor is coupled to the one or more wheels or treads to accomplish locomotion of the cart, i.e. movement from place to place, such as from a first location to a second location.

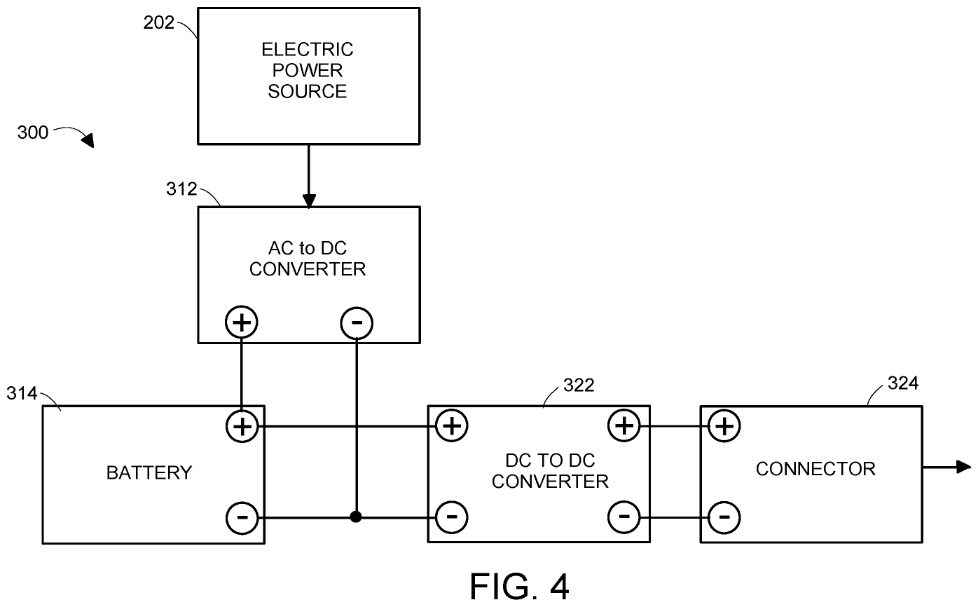

Reference is now made to FIG. 4 where there is shown a system 300 according to one or more embodiments of the present invention coupled to an AC electric power source 202. System 300 is configured to accomplish fast charging of an electric vehicle. System 300 comprises a connection to couple to AC electric power source 202 and an AC to DC converter 312 coupled to the connection to AC electric power source 202. System 300 also comprises an electric battery 314 coupled to receive power via AC to DC converter 312. System 300 comprises a DC to DC converter 322 coupled to electric battery 314 to increase the voltage of the power from electric battery 314. System 300 also comprises a connector 324 coupled to DC to DC converter 322 configured to couple to the electric vehicle to transfer power for fast charging.

Another aspect of the present invention is a combination. The combination comprises a Level II charging station configured for charging electric vehicles. The Level II charging station comprises a connector configured to provide Level II charging power to an electric vehicle. The combination also includes an electric energy storage module coupled to the Level II charging station via the connector configured to provide Level II charging power so as to receive power from the Level II charging station. The combination further includes a power coupling module connected with the electric energy storage module to receive electric power and to provide an amount of output electric power greater than the Level II charging so as to accomplish Level III power or higher power charging for electric vehicles. According to one or more embodiments of the present invention, the Level II charging power is less than 20 kW and the Level III power or higher power is greater than 20 kW. According to one or more embodiments of the present invention, the Level II charging power is less than 20 kW and the Level III power or higher power is greater than 20 kW. According to one or more embodiments of the present invention, the Level II charging power is less than 20 kW and the Level III power or higher power is from 20 kW to 350 kW and all values, ranges, and subranges subsumed therein.

According to one or more embodiments of the present invention, the combination further comprises a control and communication module connected with the energy storage module and/or the power coupling module so as to execute instructions, transmit data, receive data, control operation, and/or combinations thereof.

According to one or more embodiments of the present invention, the combination further comprises a motorized cart. The electric energy storage module and the power coupling module are supported on the motorized cart so as to achieve locomotion for the electric energy storage module and the power coupling module.

According to one or more embodiments of the present invention, the combination further comprises a motorized cart and a control and communication module. The electric energy storage module and the power coupling module are supported on the motorized cart so as to achieve locomotion for the electric energy storage module and the power coupling module. The control and communication module are connected with the motorized cart, the energy storage module, and the power coupling module so as to execute instructions, transmit data, receive data, control operation, and/or combinations thereof. The motorized cart is responsive to the control and communication module so as to accomplish remote controlled locomotion and/or self-controlled locomotion.

According to one or more embodiments of the present invention, the combination includes the electric energy storage module comprising a capacitor, an electric battery, a fuel cell, a water electrolyzer, and/or combinations thereof.

Another embodiment of the present invention is a combination comprising a source of electric power having a maximum power output of P_{M} and an electric energy storage module coupled to the source of electric power so as to receive power. The combination also comprises a power coupling module connected with the electric energy storage module to receive electric power and to provide an amount of output electric power greater than the source of electric power so as to accomplish Level III power or higher power charging for electric vehicles. The combination also comprises a motorized cart and a control and communication module. The electric energy storage module and the power coupling module are supported on the motorized cart so as to achieve locomotion for the electric energy storage module and the power coupling module. The control and communication module is connected with the motorized cart, the energy storage module, and the power coupling module so as to execute instructions, transmit data, receive data, control operation, and/or combinations thereof; the motorized cart being responsive to the control and communication module so as to accomplish remote controlled locomotion and/or self-controlled locomotion.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A method of providing electric power to a load, the method comprising:
providing a source of electric power having a maximum power output of P_{M};
providing an electric energy storage module coupled to the source of electric power to receive electric power at an amount up to P_{M} to store electric energy;
providing a power coupling module connected with the electric energy storage module to receive electric power; and
using the power coupling module and the electric energy storage module to provide an amount of output electric power to the load greater than P_{M}.

2. The method of claim 1, wherein the using the power coupling module and the electric energy storage module to provide an amount of electric power to the load greater than P_{M} is performed as batch processes.

3. The method of claim 1, wherein the using the power coupling module and the electric energy storage module to provide an amount of electric power to the load greater than P_{M} is performed as batch processes and having sufficiently long time delay between two or more batches to prevent complete depletion of the electric energy storage module.

4. The method of claim 1, wherein the load is an electric vehicle battery and the amount of output electric power to the load is greater than 20 kW.

5. The method of claim 1, wherein the load is an electric vehicle battery and the amount of output electric power to the load is greater than 30 kW.

6. The method of claim 1, wherein the load is an electric vehicle battery and the amount of output electric power to the load is greater than 40 kW.

7. The method of claim 1, wherein the load is an electric vehicle battery and the amount of output electric power to the load is greater than 50 kW.

8. The method of claim 1, wherein the amount of output electric power to the load is from 20 kW to 350 kW and all values, ranges, and subranges subsumed therein.

9. The method of claim 1, wherein the providing an electric energy storage module coupled to the source of electric power is accomplished using a releasable coupling or a non-releasable coupling between the energy storage module and the source of electric power.

10. The method of claim 1, wherein the energy storage module and the power coupling module are portable, mobile, self driven, self driven with remote control, and/or self driven with self direction.

11. A method of providing electric power to a load, the method comprising:
providing electric power up to a maximum of P_{M} from a source of electric power to an electric energy storage module while using energy from the electric energy storage module to provide electric power greater than P_{M} to the load.

12. A method of providing electric power to charge an electric vehicle battery, the method comprising:
providing electric power up to a maximum of P_{M} from a source of electric power to an electric energy storage module while using energy from the electric energy storage module to provide electric power greater than P_{M} to the electric vehicle battery.

13. A system for charging electric vehicles, the system comprising:
a source of electric power having a maximum power output of P_{M};
an electric energy storage module coupled to the source of electric power to receive electric power at an amount up to P_{M} to store electric energy; and
a power coupling module connected with the electric energy storage module to receive electric power and to provide an amount of output electric power greater than P_{M} to accomplish charging the electric vehicles.

14. The system of claim 13, wherein the amount of output electric power greater than P_{M} is from 20 kW to 120 kW and all values, ranges, and subranges subsumed therein.

15. The system of claim 13, wherein the electric energy storage module comprises one or more circuits to receive electric power for charging while providing electric power to the power coupling module.

16. A system comprising:
an electric energy storage module;
a power coupling module;
one or more circuits to receive electric power from a source of electric power having a maximum capacity P_{M}, to charge the electric energy storage module while the electric energy storage module provides energy for the power coupling module to output power greater than P_{M} for charging a battery.

17. The system of claim 16, wherein the output electric power greater than P_{M} is from 20 kW to 120 kW and all values, ranges, and subranges subsumed therein.

18. The system of claim 16, wherein P_{M} is less than 20 kW.

19. The system of claim 16, wherein P_{M} is less than 20 kW and the output electric power greater than P_{M} is from 20 kW to 120 kW and all values, ranges, and subranges subsumed therein.

20. The system of claim 16, wherein the energy storage module, the power coupling module, and the one or more circuits are portable, mobile, self driven, self driven with remote control, self driven with self direction, and/or fixed.

21. In a combination,
a Level II charging station configured for charging electric vehicles, the Level II charging station having a connector configured to provide Level II charging power to an electric vehicle;
an electric energy storage module coupled to the Level II charging station via the connector configured to provide Level II charging power so as to receive power from the level II charging station; and
a power coupling module connected with the electric energy storage module to receive electric power and to provide an amount of output electric power greater than the Level II charging so as to accomplish Level III power or higher power charging for electric vehicles.

22. The combination of claim 21, wherein the Level II charging power is less than 20 kW and the Level III power or higher power is greater than 20 kW.

23. The combination of claim 21, wherein the Level II charging power is less than 20 kW and the level III power or higher power is greater than 20 kW.

24. The combination of claim 21, wherein the level II charging power is less than 20 kW and the Level III power or higher power is from 20 kW to 120 kW and all values, ranges, and subranges subsumed therein.

25. The combination of claim 21, further comprising a control and communication module connected with the energy storage module and/or the power coupling module so as to execute instructions, transmit data, receive data, control operation, and/or combinations thereof.

26. The combination of claim 21, further comprising a motorized cart the electric energy storage module and the power coupling module being supported on the motorized cart so as to achieve locomotion for the electric energy storage module and the power coupling module.

27. The combination of claim 21, further comprising a motorized cart and a control and communication module; the electric energy storage module and the power coupling module being supported on the motorized cart so as to achieve locomotion for the electric energy storage module and the power coupling module, the control and communication module being connected with the motorized cart, the energy storage module, and the power coupling module so as to execute instructions, transmit data, receive data, control operation, and/or combinations thereof; the motorized cart being responsive to the control and communication module so as to accomplish remote controlled locomotion and/or self-controlled locomotion.

28. The combination of claim 21, wherein the electric energy storage module comprises a capacitor, an electric battery, a fuel cell, a water electrolyzer, and/or combinations thereof.

29. A system to accomplish fast charging of an electric vehicle, the system comprising:
a connection to an AC electric power source;
an AC to DC converter coupled to the connection to an AC electric power source;
an electric battery coupled to receive power via the AC to DC converter a DC to DC converter coupled to the electric battery to increase the voltage of the power from the electric battery;
a connector couple to the DC to DC converter configured to couple to the electric vehicle to transfer power for fast charging.

30. In a combination,
a source of electric power having a maximum power output of P_{M};
an electric energy storage module coupled to the source of electric power so as to receive power;
a power coupling module connected with the electric energy storage module to receive electric power and to provide an amount of output electric power greater than the source of electric power so as to accomplish DC fast charging power or higher power charging for electric vehicles;
a motorized cart and a control and communication module; the electric energy storage module and the power coupling module being supported on the motorized cart so as to achieve locomotion for the electric energy storage module and the power coupling module, the control and communication module being connected with the motorized cart, the energy storage module, and the power coupling module so as to execute instructions, transmit data, receive data, control operation, and/or combinations thereof; the motorized cart being responsive to the control and communication module so as to accomplish remote controlled locomotion and/or self-controlled locomotion.
